(19) United States
(12) Patent Application Publication
(10) Pub. No.: US 2021/0127341 A1
(43) Pub. Date: Apr. 29, 2021

(54) USER EQUIPMENT AND SYNCHRONIZATION SIGNAL TRANSMISSION METHOD

(71) Applicant: NTT DOCOMO, INC., Tokyo (JP)

(72) Inventors: Shimpei Yasukawa, Tokyo (JP); Satoshi Nagata, Tokyo (JP); Qun Zhao, Beijing (CN); Liu Liu, Beijing (CN); Anxin Li, Beijing (CN); Huiling Jiang, Beijing (CN)

(73) Assignee: NTT DOCOMO, INC., Tokyo (JP)

(21) Appl. No.: 16/074,120

(22) PCT Filed: Jan. 6, 2017
(86) PCT No.: PCT/JP2017/000217

§ 371 Date: Jul. 31, 2018

(30) Foreign Application Priority Data
Feb. 4, 2016 (JP) 2016-020326

(51) Int. Cl. H04W 56/00; H04W 4/70; H04W 24/10; H04B 17/318

(52) U.S. Cl. CPC H04W 56/001; H04B 17/318; H04W 24/10; H04W 4/70

(57) ABSTRACT

There is provided user equipment of a radio communication system that supports D2D communication, the user equipment including a receiver configured to receive a predetermined synchronization signal; a synchronization processor configured to perform a process for synchronizing with the predetermined synchronization signal; and a transmitter configured to transmit a synchronization signal in a subframe that is the same as that of a synchronization signal transmitted from any other user equipment when the synchronization signal transmitted from the other user equipment is received by the receiver and received power of the synchronization signal transmitted from the other user equipment is less than a predetermined threshold value, wherein the transmitter interrupts transmission of the synchronization signal for a predetermined time interval, and the receiver measures the received power of the synchronization signal transmitted from the other user equipment in the predetermined time interval.

### TECHNICAL FIELD

The present invention relates to user equipment and a synchronization signal transmission method.

### BACKGROUND ART

In a long term evolution (LTE) system or a successive system of the LTE system (also referred to as, for example, LTE advanced (LTE-A), 4G, or future radio access (FRA)), a device to device (D2D) technology has been studied that allows units of user equipment to directly communicate with each other without using a radio base station (for example, see Non-Patent Document 1).

The D2D technology can reduce traffic between user equipment and a base station and enables communication between units of user equipment, even if a base station is unable to communicate at the time of disaster, etc.

The D2D technology is roughly classified into D2D discovery (D2D discovery, which is also referred to as D2D detection) for discovering any other user equipment which can communicate and D2D communication (D2D direct communication, which is also referred to as D2D communication or inter-terminal direct communication) for performing direct communication between units of user equipment. Hereinafter, when the D2D communication and the D2D discovery are not particularly distinguished, the D2D communication and the D2D discovery are simply referred to as D2D. A signal which is transmitted and received by D2D is referred to as a D2D signal.

In a 3rd Generation Partnership Project (3GPP), it has been studied to achieve V2X by extending a D2D function. Here, V2X is a part of intelligent transport systems (ITS) and is a generic term of vehicle to vehicle (V2V) referring to a communication scheme which is performed between vehicles, vehicle to infrastructure (V2I) referring to a communication scheme which is performed between a vehicle and a road-side unit (RSU) installed at a roadside, vehicle to nomadic device (V2N) referring to a communication scheme which is performed between a vehicle and a mobile terminal of a driver, and vehicle to pedestrian (V2P) referring to a communication scheme which is performed between a vehicle and a mobile terminal of a pedestrian as illustrated in FIG. 1.

### PRIOR ART DOCUMENT

### Non-Patent Document

Non-Patent Document 1: “Key drivers for LTE success: Services Evolution”, September, 2011, 3GPP, Internet URL: http://www.3gpp.org/ftp/Information/presentations/presentations_2011/2011_09_LTE_Asia/2011LTE-Asia_3GPP_Service_evolution.pdf
Non-Patent Document 2: 3GPP TS36.300 V13.2.0 (2015 December)

### SUMMARY OF THE INVENTION

### Problem to be Solved by the Invention

There is a need for a technique that allows a synchronization process to be properly performed in D2D.

### Means for Solving Problem

According to an aspect of the present invention, there is provided user equipment of a radio communication system that supports D2D communication, the user equipment including a receiver configured to receive a predetermined synchronization signal; a synchronization processor configured to perform a process of synchronizing with the predetermined synchronization signal; and a transmitter configured to transmit, upon detecting that the synchronization signal transmitted from the other user equipment is received by the receiver and that received power of the synchronization signal transmitted from the other user equipment is less than a predetermined threshold value, a synchronization signal through a subframe that is the same as that of a synchronization signal transmitted from any other user equipment, wherein the transmitter interrupts transmission of the synchronization signal for a predetermined time interval, and the receiver measures the received power of the synchronization signal transmitted from the other user equipment in the predetermined time interval.

### Effect of the Invention

According to the disclosed technology, a technique is provided that allows a synchronization process to be properly performed in D2D.

### BRIEF DESCRIPTION OF DRAWINGS

FIG. 1 is a diagram illustrating V2X;

FIG. 2 is a diagram illustrating a problem;

FIG. 3 is a diagram illustrating the problem;

FIG. 4A is a diagram illustrating D2D;

FIG. 4B is a diagram illustrating D2D;

FIG. 5A is a diagram illustrating a physical channel assumed in the D2D;

FIG. 5B is a diagram illustrating the physical channel assumed in the D2D;

FIG. 6 is a diagram illustrating an example of a configuration of a radio communication system of embodiments;

FIG. 7 is a diagram illustrating an outline of operations which are performed by a radio communication system according to an embodiment;

FIG. 8 is a diagram illustrating a synchronization signal transmission method (version 1) according to the embodiment;

FIG. 9 is a diagram illustrating an operation in which user equipment alternately performs transmission of a synchronization signal and measurement of received power;

FIG. 10 is a flowchart illustrating a processing sequence of changing a period in which a synchronization signal is transmittable for each user equipment;

FIG. 11 is a diagram illustrating a synchronization signal transmission method (version 2) according to the first embodiment;

FIG. 12 is a sequence diagram illustrating an example of a processing sequence for terminating transmission of a synchronization signal;

FIG. 13 is a flowchart illustrating an example of a processing sequence which is performed by the user equipment according to another embodiment;

FIG. 14 is a sequence diagram illustrating an example of a processing sequence when the user equipment starts transmission of a synchronization signal according to another embodiment;

FIG. 15 is a sequence diagram illustrating an example of a processing sequence when user equipment interrupts transmission of a synchronization signal according to the other embodiment;

FIG. 16 is a diagram illustrating an example of an operation of user equipment according to the other embodiment;

FIG. 17 is a diagram illustrating a modified example of the other embodiment;

FIG. 18 is a diagram illustrating an example of a functional configuration of the user equipment according to the embodiments;

FIG. 19 is a diagram illustrating an example of a functional configuration of a base station according to the embodiments;

FIG. 20 is a diagram illustrating an example of a hardware configuration of the user equipment according to the embodiments; and

FIG. 21 is a diagram illustrating an example of a hardware configuration of the base station according to the embodiments.

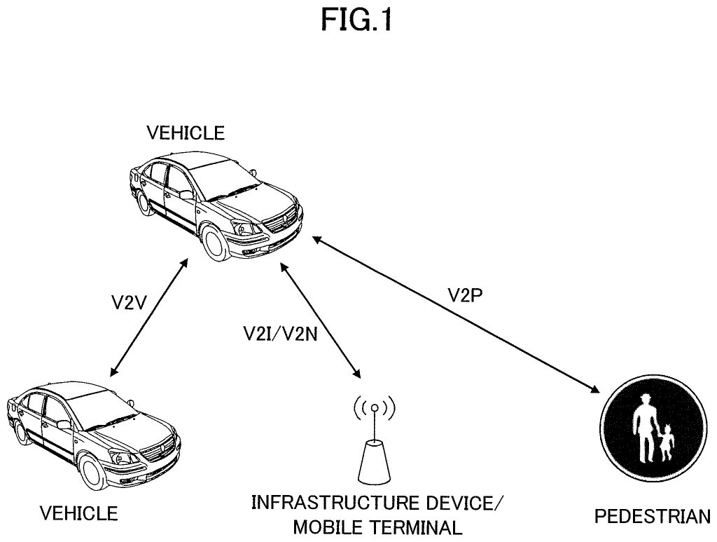

### EMBODIMENTS OF THE INVENTION

In D2D, user equipment transmits a synchronization signal with a cycle of 40 ms when a predetermined condition such as a condition that the user equipment is located at a cell end of a base station eNB is satisfied. The user equipment does not always transmit the synchronization signal but transmits the synchronization signal when a control signal (SCI: Sidelink Control Information) and data (PSSCH: Physical Sidelink Shared Channel) are transmitted.

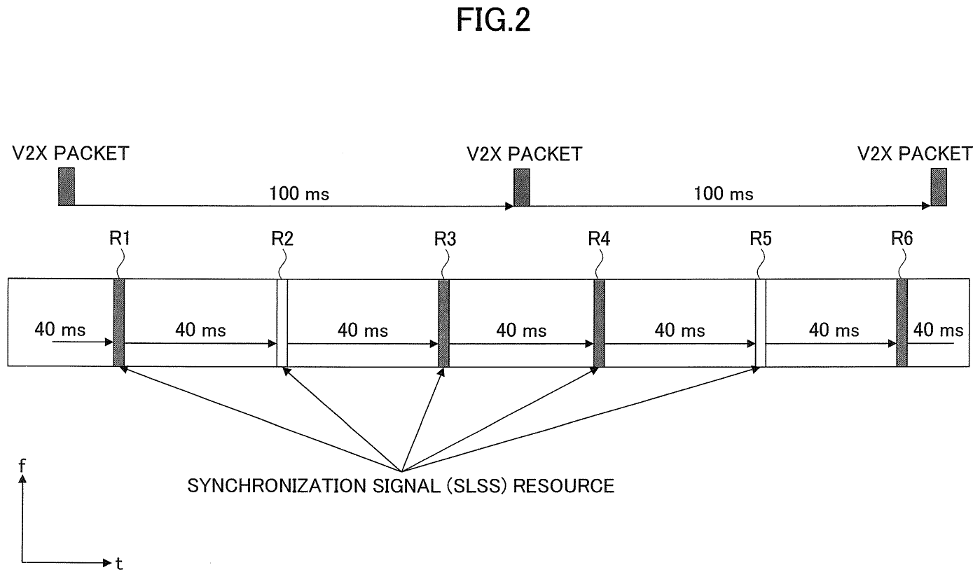

Here, in the V2X (particularly the V2V), a scenario is assumed such that a packet of about 100 byte is mainly periodically (about 100 ms to 1 sec) transmitted and received between units of user equipment. If usual D2D rules are applied to this scenario, it is assumed that the user equipment operates to transmit a synchronization signal only before and after times at which a control signal and data are transmitted. Specifically, as illustrated in FIG. 2, it is assumed that the user equipment operates to transmit a synchronization signal using only resources (R1, R3, R4, and R6) before and after a V2X packet is transmitted. In this case, the user equipment receiving a synchronization signal transmitted from V2X user equipment is to receive the synchronization signal transmitted in a toothless manner, so that the synchronization process may not be correctly performed.

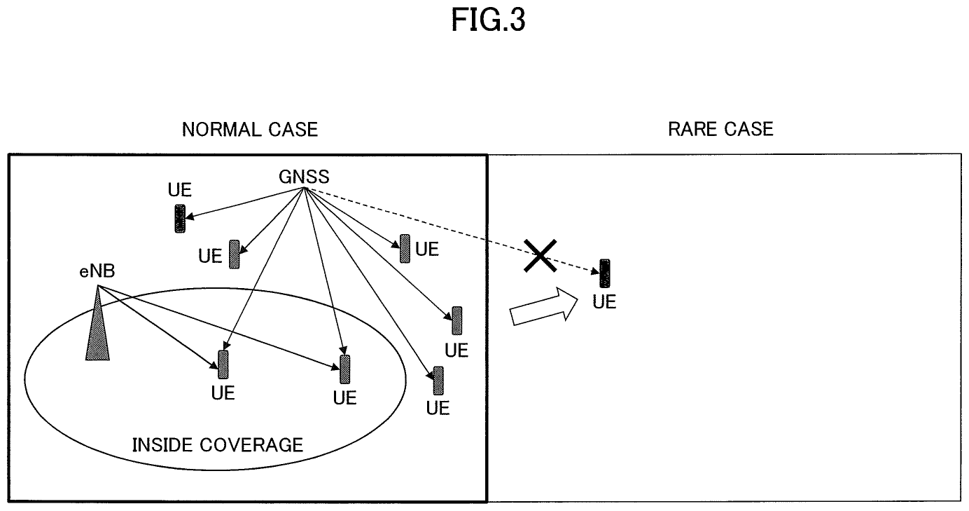

In the study of the V2X in the 3GPP, it is assumed that a global navigation satellite system (GNSS) signal in addition to a synchronization signal transmitted from a base station is used as a synchronous signal (on the left in FIG. 3). Since a synchronization signal from the GNSS can be basically received in all places in the world, a case is assumed to be rare in which user equipment cannot receive both the synchronization signal from a base station and the synchronization signal from the GNSS (a case in which the user equipment is isolated) (on the right side in FIG. 3). However, in consideration of presence of tunnels and so forth, it is preferable that a synchronization signal be relayed from user equipment synchronized with a synchronization signal from a base station or a GNSS to such isolated user equipment.

However, if user equipment UE operates to transmit a synchronization signal when a predetermined condition specified in usual D2D is satisfied, all units of user equipment located outside a cell end (an end of a cell formed by a base station) or the coverage of the base station transmit a synchronization signal in spite of an environment in which all the units of user equipment can receive a synchronization signal of the GNSS in a surrounding area. This situation is considered not to be appropriate because radio resources and power of the user equipment are uselessly consumed. When V2X is considered to be a part of D2D, the same problem may occur in the D2D.

Embodiments of the present invention is described below by referring to the accompanying drawings. The embodiments described below are only examples and embodiments of the present invention are not limited to the embodiments below. For example, a radio communication system according to the embodiments is assumed to be a LTE-based system, however, the present invention is not limited to the LTE and can be applied to another scheme. In the specification and the claims, “LTE” is used with a wide meaning including, not only the communication schemes corresponding to Release 8 or 9 of 3GPP, but also Releases 10, 11, 12, and 13 of 3GPP, or the 5G communication scheme which corresponds to on and after Release 14

The embodiments are mainly directed to V2X, but the techniques according to the embodiments are not limited to V2X, but can be broadly applied to D2D, in general. “D2D” includes V2X in view of meanings thereof.

“D2D” is used with a wide meaning including a processing sequence of transmitting and receiving D2D signals between units of user equipment UEs, a processing sequence of causing a base station to receive (monitor) D2D signals, and a processing sequence of causing user equipment UE to transmit an uplink signal to a base station eNB when the user equipment UE is RRC idle or when a connection to the base station eNB is not established.

In the following description, for example, a GNSS is used as an external synchronization source. However, the embodiments are not limited to the GNSS and can be applied to cases in which a radio set, a television, WiFi (registered trademark), or the like is used as an external synchronization source.

In the embodiments, “synchronization” is used with a meaning including time synchronization (which includes radio frame synchronization and symbol timing synchronization) and frequency synchronization.

<Outline of D2D>

First, the outline of D2D is described, which is specified in LTE. The technique of D2D described herein can be used for V2X and user equipment UE in the embodiments of the present invention can transmit and receive a D2D signal based on the technique.

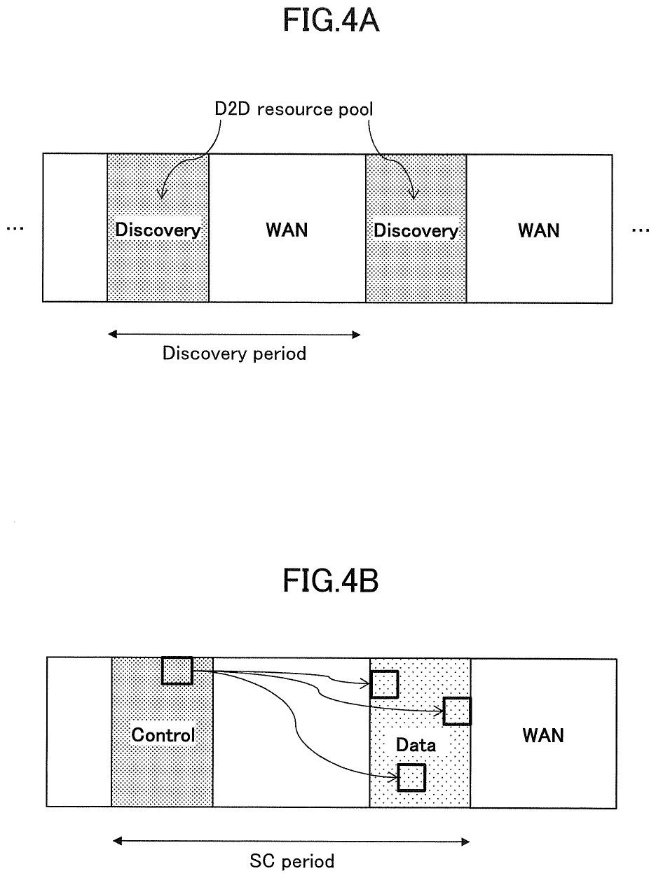

As described above, the D2D is roughly classified into “D2D discovery” and “D2D communication.” In the “D2D discovery,” as illustrated in FIG. 4A, a resource pool for discovery messages is secured for each discovery period and user equipment UE transmits a discovery message in the resource pool. More specifically, there are Type 1 and Type 2b. In Type 1, user equipment UE autonomously selects transmission resources from the resource pool. In Type 2b, quasi-static resources are allocated by high layer signaling (for example, RRC signaling).

In the “D2D communication,” as illustrated in FIG. 4B, a resource pool for transmission of SCI/data is also periodically secured. A transmitting-side user equipment UE notifies a receiving side of data transmission resources and the like by the SCI using resources selected from a control resource pool (an SCI transmission resource pool) and transmits data using the data transmission resources. In the “D2D communication,” more specifically, there are Mode 1 and Mode 2. In Mode 1, resources are dynamically allocated by (E)PDCCH sent from a base station eNB to user equipment UE. In Mode 2, user equipment UE autonomously selects transmission resources from the resource pool. The resource pool is notified by SIB or is defined in advance.

In the LTE, a channel which is used for the “D2D discovery” is referred to as physical sidelink discovery channel (PSDCH), a channel which is used to transmit control information such as SCI in the “D2D communication” is referred to as physical sidelink control channel (PSCCH), and a channel which is used to transmit data is referred to as physical sidelink shared channel (PSSCH).

In order to achieve D2D communication outside the coverage of a base station eNB, it is specified that user equipment UE transmits (relays) a synchronization signal (SLSS) when a predetermined condition is satisfied. More specifically, the SLSS includes primary sidelink synchronization signal (PSSS) and secondary sidelink synchronization signal (SSSS). User equipment UE that transmits an SLSS can notify user equipment UE, which is present outside the coverage, of a radio frame number (DFN: Direct Frame Number), a system bandwidth, and the like using a physical channel called physical sidelink broadcast control channel (PSBCH).

When a predetermined condition is satisfied (when user equipment is located at an end of a cell), user equipment UE present in the coverage of a base station eNB operates to transmit (relay) an SLSS on the basis of a synchronization timing of a synchronization signal (SS) transmitted from the base station eNB. Accordingly, user equipment UE present outside the coverage can also perform D2D communication on the basis of the synchronization timing of the base station eNB. User equipment UE (user equipment UE which is not synchronized with the SS and the SLSS) which is isolated outside the coverage transmits an SLSS on the basis of a clock which is generated from an oscillator built therein in order to synchronize the synchronization timing with that of any other user equipment UE.

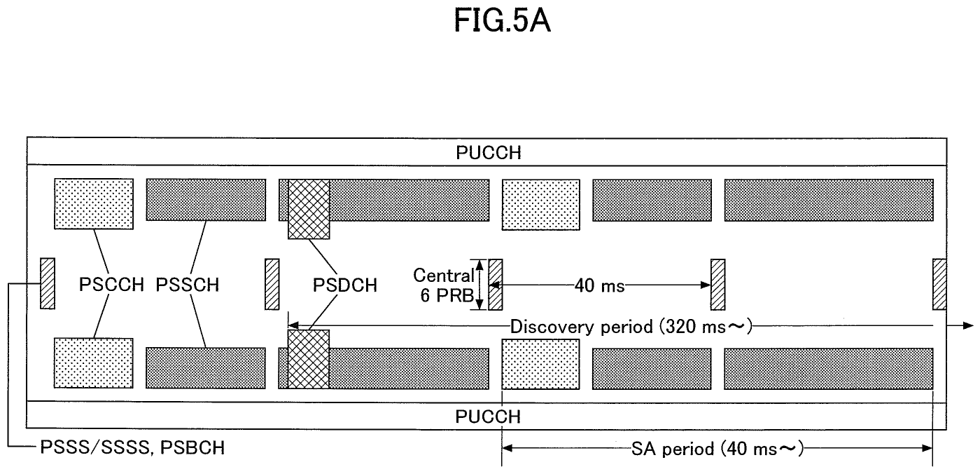

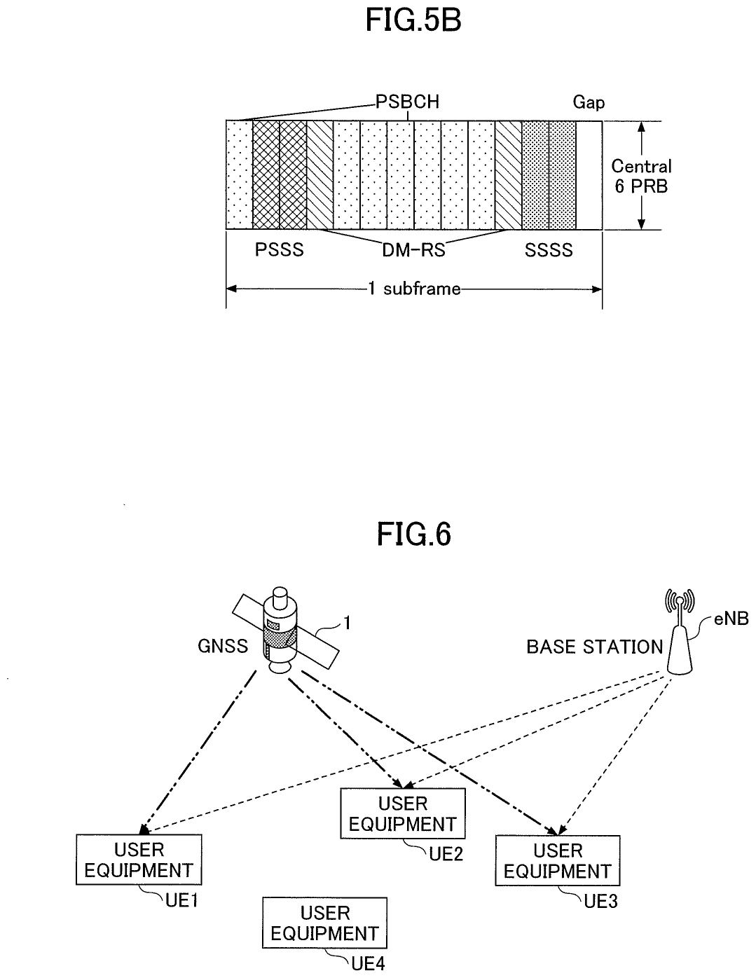

Next, SLSS and PSBCH are described, which are specified in D2D. FIG. 5A illustrates the entire configuration of a physical channel in the D2D. FIG. 5B illustrates the specific configurations of an SLSS (PSSS/SSSS) and a PSBCH.

As illustrated in FIG. 5A, the PSSS, the SSSS, and the PSBCH are transmitted at 40 ms intervals using six physical resource blocks (PBRs) at the center of a frequency band. As illustrated in FIG. 5B, as for the PSSS, the SSSS, and the PSBCH, the PSSS and the SSSS are mapped on predetermined SC-FDMA symbols in one subframe, and the PSBCH is mapped on SC-FDMA symbols other than the PSSS, the SSSS, and a demodulation-reference signal (DM-RS).

In the usual D2D, two types of SLSSs are defined, which are an SLSS that is transmitted within the coverage and in the vicinity of the coverage (Partial coverage) and an SLSS transmitted outside the coverage. A PSSS transmitted within the coverage and in the vicinity of the coverage is a Zadoff-Chu sequence with a route index “26” and a sidelink ID (SLID) in a range from 0 to 167 is identified by the PSSS and the SSSS. A PSSS transmitted outside the coverage is a Zadoff-Chu sequence with a route index “37,” and a sidelink ID (SLID) in a range from 168 to 355 is identified by the PSSS and the SSSS. The SLID is also referred to as an SLSS ID. An identifier called in-coverage indicator is stored in the PSBCH, which is set to “1 (TRUE)” for inside the coverage and which is set to “0 (FALSE)” for outside the coverage (which includes the vicinity of the coverage). Three types of priority groups are defined by combinations of the SLID and the in-coverage indicator. Specifically, Priority group 1 is defined to be a case in which the SLID is in the range from 0 to 167 and the In-coverage indicator is “1 (TRUE),” Priority group 2 is defined to be a case in which the SLID is in the range from 0 to 167 and the In-coverage indicator is “0 (FALSE),” and Priority group 3 is defined to be a case in which the SLID is in the range from 168 to 355 and the In-coverage indicator is “0 (FALSE).”

In the usual D2D, priority order is specified which indicates that, when an SS, an SLSS transmitted inside the coverage, and an SLSS transmitted outside the coverage are received, the user equipment UE is to be synchronized with which synchronization signal. It is specified that the SS has a highest priority level, the SLSS (Priority group 1) transmitted inside the coverage has a second highest priority level, and the SLSS (Priority group 2 or 3) transmitted outside the coverage has a lowest priority level.

In the following description, when it is mentioned that user equipment UE “transmits a synchronization signal,” it means that a signal of a physical channel (a signal having a channel configuration illustrated in FIG. 5B) including an SLSS, a DM-RS, and a PBSCH is transmitted, unless otherwise mentioned. A synchronization signal and a channel configuration are not limited thereto, but when a new synchronization signal or channel configuration is defined in the D2D or V2X, the synchronization signal of the embodiments includes the new synchronization signal and channel configuration.

<System Configuration>

As illustrated in FIG. 6, a radio communication system according to the embodiments includes a GNSS 1, a base station eNB, and units of user equipment UE1 to UE4.

The units of user equipment UE1 to UE4 have functions for performing D2D communication with each other. In the following description, any one unit among the units of user equipment UE1 to UE4 is referred to as “user equipment UE.” User equipment UE may be any device having a D2D function, and examples of the user equipment UE include a terminal carried by a vehicle or pedestrian and a RSU (a UE type RSU having a UE function).

The base station eNB has a cellular communication function as a base station eNB in the LTE and functions for enabling communication of user equipment UE in the embodiments (such as a resource allocating function and a configuration information signaling function). The base station eNB transmits a synchronization signal (SS) to units of user equipment UE. More specifically, the SS includes a primary synchronization signal (PSS) and a secondary synchronization signal (SSS). The base station eNB may have a function of monitoring a D2D signal in addition to the cellular communication function. The base station eNB includes an RSU (an eNB type RSU having an eNB function).

The GNSS 1 transmits a synchronization signal (for example, a GPS signal) to the ground and user equipment UE receiving the synchronization signal of the GNSS 1 performs synchronization using the synchronization signal. Any method can be used as a method of causing user equipment UE to perform synchronization with the synchronization signal of the GNSS 1. For example, user equipment UE may perform synchronization using information for specifying a coordinated universal time (UTC) included in the synchronization signal and “information for correlating the UTC with a radio frame number (SFN or DFN)” which is set in advance in the user equipment UE.

In FIG. 6, it is assumed that the units of user equipment UE1 to UE3 are synchronized with a synchronization signal transmitted from the GNSS 1 or the base station eNB. In other words, the units of user equipment UE1 to UE3 correspond to a “normal case” on the left side in FIG. 3. It is assumed that the user equipment UE4 is not synchronized with the synchronization signal transmitted from the GNSS 1 and the base station eNB (does not receive the synchronization signal transmitted from the GNSS 1 and the base station eNB) and is isolated. In other words, the user equipment UE4 corresponds to a “rare case” on the right side in FIG. 3.

A processing sequence which is performed by the radio communication system according to the embodiment is described below.

### Embodiment

(Outline)

In this embodiment, user equipment UE synchronized with the GNSS 1 or the base station eNB operates to transmit a synchronization signal from the user equipment UE itself when a synchronization signal transmitted from any other user equipment UE is not received or when received power of a synchronization signal (S-RSRP: Sidelink-Reference Signal Received power) transmitted from any other user equipment UE is less than a predetermined threshold value. The user equipment UE determining that a synchronization signal should be transmitted operates to transmit the synchronization signal regardless of whether a control signal and data are transmitted. The user equipment UE transmitting the synchronization signal operates to interrupt transmission of the synchronization signal when the received power of the synchronization signal transmitted from any other user equipment UE is greater than the predetermined threshold value.

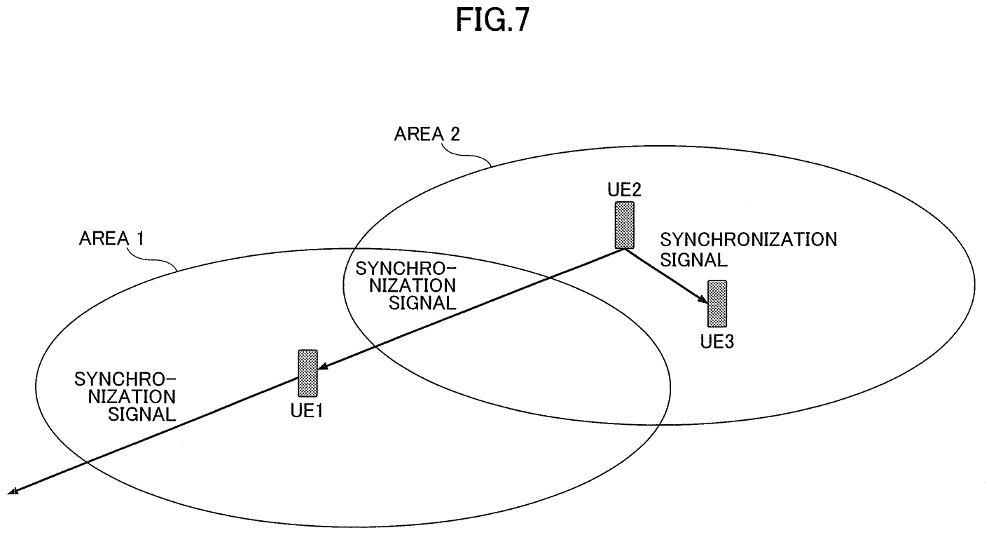

FIG. 7 is a diagram illustrating an outline of operations which are performed by the radio communication system according to the embodiment. As described above with reference to FIG. 6, it is assumed that the units of user equipment UE1 to UE3 are synchronized with the GNSS 1 or the base station eNB.

It is also assumed that the user equipment UE2 determines that a synchronization signal transmitted from any other user equipment UE is not received and starts transmission of a synchronization signal. Subsequently, the user equipment UE1 and the user equipment UE3 receive the synchronization signal transmitted from the user equipment UE2 and measure the received power of the received synchronization signal. Since the received power of the synchronization signal transmitted from the user equipment UE 2 is in a range (“Area 2” in FIG. 7) exceeding the predetermined threshold value, the user equipment UE3 determines that the received power of the synchronization signal is greater than the predetermined threshold value and does not transmit a synchronization signal. However, since the received power of the synchronization signal transmitted from the user equipment UE2 is in a range (“Area 1” in FIG. 7) that is less than the predetermined threshold value, the user equipment UE1 determines that the received power of the synchronization signal is less than the predetermined threshold value and transmits a synchronization signal.

(Synchronization Signal Transmission Method (Version 1))

A synchronization signal transmission method (version 1) by which user equipment UE transmits a synchronization signal is described below.

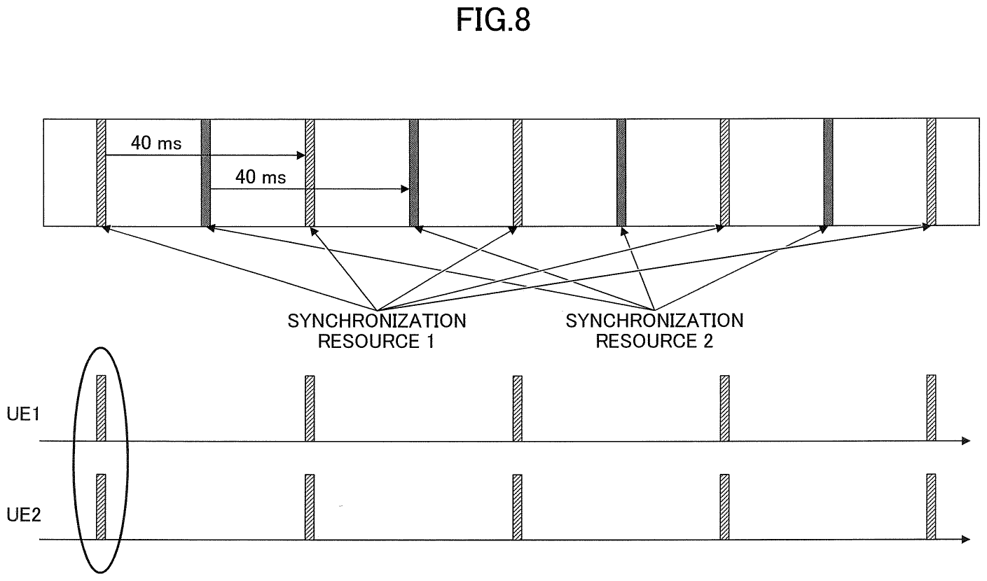

FIG. 8 is a diagram illustrating the synchronization signal transmission method (version 1) according to the embodiment. The user equipment UE1 and the user equipment UE2 illustrated in FIG. 8 correspond to the user equipment UE1 and the user equipment UE2 illustrated in FIG. 7, respectively.

In this embodiment, positions (positions of subframes) of two or more radio resources (hereinafter referred to as “synchronization resources”) by which a synchronization signal can be transmitted are configured in advance for each user equipment UE. The configuration method may be any method, and may be specified as a standard specification in advance, may be configured from the base station eNB to the user equipment UE using broadcast information (SIB: System Information Block) or RRC signaling, or may be pre-configured in the user equipment UE via a subscriber identity module (SIM), a core network, or the like. The position of a synchronization resource may be designated by a radio frame number (SFN or DFN) and a subframe number or may be designated by an offset value from a predetermined start position (for example, the head of a resource pool). When broadcast information is used, for example, the position of a synchronization resource may be configured by an “SL-OffsetIndicator information element.” However, it is not limited this, and the position of the synchronization resource may be configured by another information element (IE).

In the following description, it is assumed that “Synchronization Resource 1” and “Synchronization Resource 2” are configured as the synchronization resources. It is assumed that “Synchronization Resource 1” and “Synchronization Resource 2” are configured in subframes with a cycle of 40 ms, similar to the usual D2D; however, it is not limited to this, and the synchronization resources may be configured with a cycle other than 40 ms.

In the synchronization signal transmission method (version 1), user equipment UE transmitting a synchronization signal operates to transmit the synchronization signal using the same synchronization resource as a synchronization signal (a synchronization signal transmitted from any other user equipment UE) for which the received power has been measured.

More specifically, when the received power of a synchronization signal from any other user equipment UE is measured, user equipment UE measures the received power for all the resources configured as the synchronization resources, and selects the same synchronization resource as the received synchronization signal and transmits a synchronization signal when the received power of the received synchronization signal is less than a predetermined threshold value. For example, as illustrated in FIG. 8, when the user equipment UE2 transmits a synchronization signal using Synchronization Resource 1, the user equipment UE1 also operates to transmit a synchronization signal using Synchronization Resource 1. When synchronization signals are received using multiple synchronization resources and the received power of the synchronization signals is less than the predetermined threshold value, the user equipment UE may select the same synchronization resource as the synchronization resource by which a synchronization signal having a largest received power has been transmitted among the synchronization signals and transmit the synchronization signal.

It is preferable that the synchronization signals which are transmitted from the user equipment UE1 and the user equipment UE2 be synchronization signals which are the same radio signals. As a result, the user equipment UE1 and the user equipment UE2 transmit synchronization signals in cooperation with each other and any other user equipment UE (for example, the user equipment UE4 in FIG. 6) combines and receives the synchronization signals, thereby enhancing synchronization accuracy.

As described above in the “(Outline),” user equipment UE operates to transmit a synchronization signal when the received power of a synchronization signal transmitted from any other user equipment UE is less than the predetermined threshold value and to interrupt transmission of the synchronization signal when the received power is greater than the predetermined threshold value. That is, the user equipment UE needs to continuously measure the received power of a synchronization signal transmitted from any other user equipment UE. Since the D2D communication employs a half duplex communication scheme in which transmission and reception of a D2D signal is performed using the same carrier, user equipment UE is not allowed to simultaneously transmit and receive a D2D signal (which includes a synchronization signal) in the same subframe. Then, in the synchronization signal transmission method (version 1), the user equipment UE1 and the user equipment UE2 transmitting the synchronization signals using the same synchronization resource are not able to measure the received power of the synchronization signal transmitted from the opposite user equipment UE.

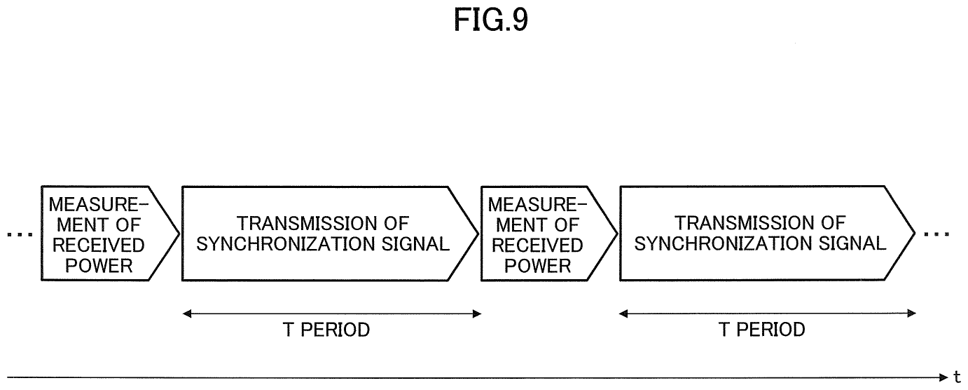

Therefore, in the synchronization signal transmission method (version 1), as illustrated in FIG. 9, user equipment UE may transmit a synchronization signal for a predetermined time interval “T period” indicating a period in which a synchronization signal can be transmitted and temporarily stop transmission of the synchronization signal and measure the received power of a synchronization signal transmitted from any other user equipment UE in a period other than the “T period.” The “T period” may be specified as a standard specification in advance, may be configured from the base station eNB to the user equipment UE using broadcast information (SIB) or RRC signaling, or may be pre-configured in the user equipment UE via a SIM, a core network, or the like.

In another method, the “T period” may be changed for each user equipment UE such that multiple units of user equipment UE do not simultaneously perform transmission/stop of synchronization signals.

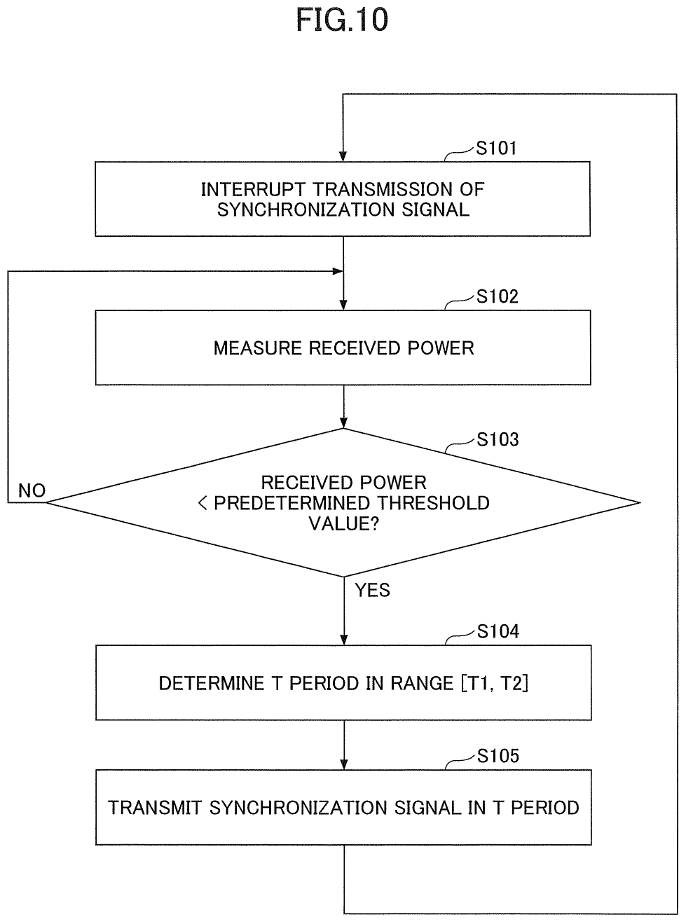

FIG. 10 is a flowchart illustrating a processing sequence of changing, for each user equipment, the period in which a synchronization signal can be transmitted. First, user equipment UE interrupts transmission of a synchronization signal (S101) and measures the received power of a synchronization signal transmitted from any other user equipment UE (S102). Step S104 is performed when the measured received power is less than a predetermined threshold value (YES in S103), and Step S102 is performed again, if the measured received power is greater than the predetermined threshold value (NO in S103). Subsequently, the user equipment UE determines a T period between “T1 and T2” (S103). The user equipment UE may randomly determine the T period between T1 and T2 or may determine the T period on the basis of the magnitude of the received power received in the processing sequence of step S102. Subsequently, the user equipment UE transits a synchronization signal in the “T period” (S105).

(Synchronization Signal Transmission Method (Version 2))

A transmission method (version 2) of transmitting a synchronization signal by the user equipment UE is described below.

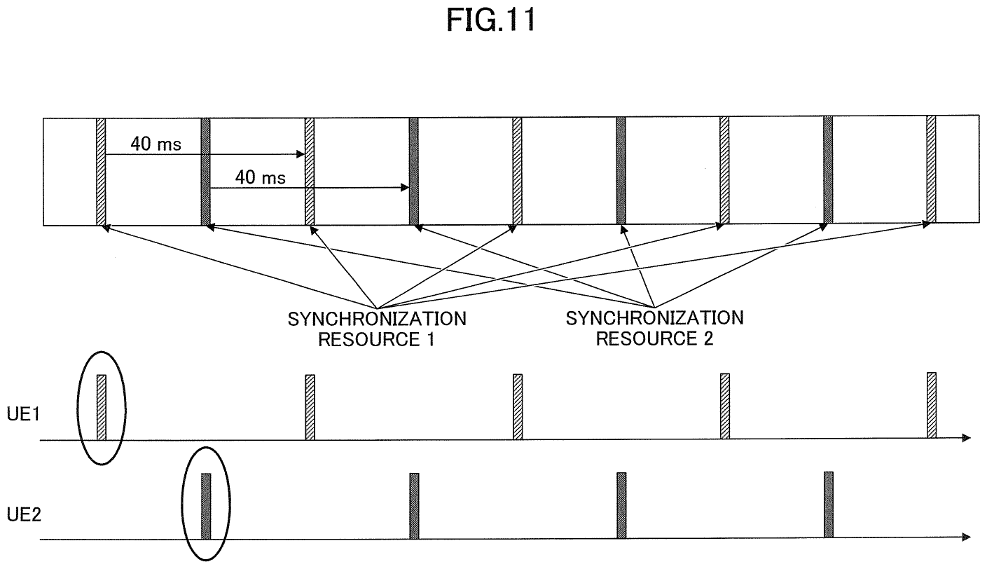

FIG. 11 is a diagram illustrating the synchronization signal transmission method (version 2) according to the embodiment. The user equipment UE1 and the user equipment UE2 illustrated in FIG. 11 correspond to the user equipment UE1 and the user equipment UE2 illustrated in FIG. 7, respectively.

In the synchronization signal transmission method (version 2), unlike the synchronization signal transmission method (version 1), user equipment UE transmitting a synchronization signal operates to transmit the synchronization signal using a synchronization resource different from that of a synchronization signal for which the received power is measured (a synchronization signal transmitted from any other user equipment UE). The user equipment UE determining that a synchronization signal should be transmitted operates to transmit the synchronization signal regardless of whether a control signal and data are transmitted.

More specifically, when the received power of a synchronization signal from any other user equipment UE is measured, user equipment UE measures the received power for all the resources configured as the synchronization resources, and selects a synchronization resource different from that of the received synchronization signal and transmits a synchronization signal when the received power of the received synchronization signal is less than a predetermined threshold value. When synchronization signals are received using multiple synchronization resources and the received power of the synchronization signals is less than the predetermined threshold value, the user equipment UE may select a synchronization resource different from the synchronization resource by which a synchronization signal having largest received power has been transmitted among the synchronization signals and transmit the synchronization signal.

The user equipment UE measures the received power of the synchronization signal transmitted using a synchronization resource different from that of the synchronization signal which is transmitted by the user equipment itself, and interrupts transmission of the synchronization signal if there exists at least one synchronization signal with the received power that is greater than the predetermined threshold value, in the received power of the received synchronization signals.

In the synchronization signal transmission method (version 2), as illustrated in FIG. 11, the user equipment UE1 operates to transmit a synchronization signal using Synchronization Resource 1, which is different from Synchronization Resource 2 that is used by the synchronization signal transmitted from the user equipment UE2. As a result, the user equipment UE1 can measure the received power of the synchronization signal using Synchronization Resource 2. That is, in the synchronization signal transmission method (version 2), a problem based on the fact that the D2D communication is half duplex does not occur as described above in the synchronization signal transmission method (version 1).

However, in the synchronization signal transmission method (version 2), when a distance between two units of user equipment UE which measure the received power of the synchronization signals from each other decreases, a problem may arise such that both units of user equipment UE determine that the received power is greater than the predetermined threshold value and simultaneously interrupt transmission of the synchronization signals.

In order to avoid occurrence of such a problem, in the synchronization signal transmission method (version 2), a predetermined time interval (“T period”) until transmission of a synchronization signal is interrupted may be provided and the “T period” may be randomly determined for each user equipment UE.

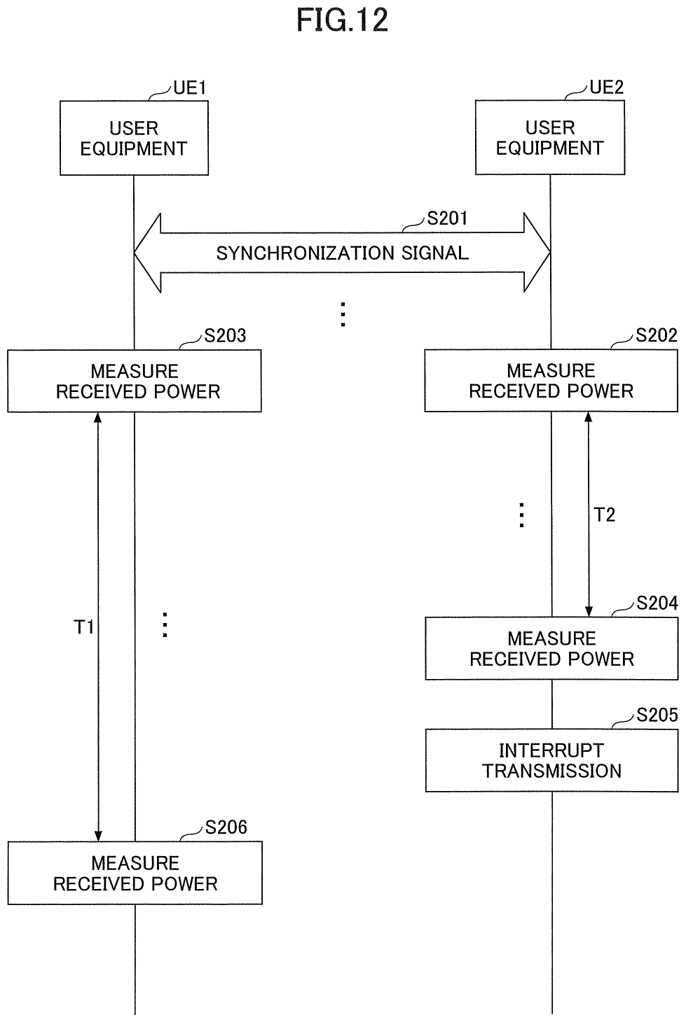

FIG. 12 is a sequence diagram illustrating an example of a processing sequence when transmission of a synchronization signal is interrupted. First, the user equipment UE1 and the user equipment UE2 transmit synchronization signals using different synchronization resources (S201). In this state, it is assumed that the distance between the user equipment UE1 and the user equipment UE2 decreases. The user equipment UE2 measures the received power of the synchronization signal transmitted from the user equipment UE1 (S202). Upon detecting that the measured received power is greater than the predetermined threshold value, the user equipment UE2 randomly determines the “T period” and starts a backoff timer. In the example illustrated in FIG. 12, it is assumed that a determination is made that the measured received power exceeds the predetermined threshold value, and that the “T period” is determined to be T2.

Similarly, the user equipment UE1 measures the received power of the synchronization signal transmitted from the user equipment UE2 (S203). Upon detecting that the measured received power is greater than the predetermined threshold value, the user equipment UE1 randomly determines the “T period” and starts a backoff timer. In the example illustrated in FIG. 12, it is assumed that a determination is made that the measured received power is greater than the predetermined threshold value and the “T period” is determined to be T1. In the example illustrated in FIG. 12, it is assumed that T1>T2 is determined.

The user equipment UE2 determines whether the received power of the synchronization signal transmitted from the user equipment UE1 is greater than the predetermined threshold value until the backoff timer expires (becomes zero) (S204). When a determination is made that the received power of the synchronization signal is continuously greater than the predetermined threshold value until the backoff timer expires, the user equipment UE2 interrupts transmission of the synchronization signal. However, when it is detected that the received power of the synchronization signal is less than the predetermined threshold value until the backoff timer expires, the user equipment UE2 stops the backoff timer. That is, the user equipment UE2 operates not to interrupt transmission of the synchronization signal. In the example illustrated in FIG. 12, it is assumed that the received power of the synchronization signal is continuously greater than the predetermined threshold value until the backoff timer expires and that the user equipment UE2 interrupts transmission of the synchronization signal (S205).

Similarly, the user equipment UE1 measures whether the received power of the synchronization signal transmitted from the user equipment UE2 is greater than the predetermined threshold value until the backoff timer expires (S206). In the example illustrated in FIG. 12, since the user equipment UE2 interrupts transmission of the synchronization signal (S205), the user equipment UE1 detects that the received power of the synchronization signal is less than the predetermined threshold value until the backoff timer expires and stops the backoff timer. That is, the user equipment UE1 operates not to interrupt transmission of the synchronization signal.

The “T period” may be randomly determined by the user equipment UE. A range which can be selected as the “T period” may be specified as a standard specification in advance, may be configured from the base station eNB to the user equipment UE using broadcast information (SIB) or RRC signaling, or may be pre-configured in the user equipment UE via a SIM, a core network, or the like.

The embodiment is described above. According to the embodiment, the user equipment UE transmitting a synchronization signal operates to transmit the synchronization signal regardless of whether a control signal and data are transmitted. As a result, as described above with reference to FIG. 2, it is possible to solve the problem in that the synchronization signal is transmitted in a toothless manner. According to the embodiment, the user equipment UE synchronized with the GNSS 1 or the like operates to transmit a synchronization signal when the received power of a synchronization signal received from any other user equipment UE is less than the predetermined threshold value. As a result, as described above with reference to FIG. 3, it is possible to solve the problem in that all the units of user equipment synchronized with the GNSS 1 or the like uselessly consume the radio resources and power of the units of user equipment by transmitting the synchronization signals in spite of an environment in which the units of user equipment can receive the synchronization signal of the GNSS 1 from the surrounding area.

### Another Embodiment

In this embodiment, user equipment UE synchronized with the GNSS 1 or the base station eNB operates to transmit, by the user equipment UE itself, a synchronization signal regardless of the received power of a synchronization signal transmitted from any other user equipment UE. The user equipment UE operates to change the transmission power of a synchronization signal to be transmitted by the user equipment UE itself on the basis of the received power of the synchronization signal transmitted from any other user equipment UE. For example, in FIG. 7, the user equipment UE3 operates not to transmit a synchronization signal; however, in this embodiment, the user equipment UE3 operates to transmit a synchronization signal while controlling the transmission power.

The embodiment is different from the above-described embodiment, in that a synchronization signal is transmitted regardless whether the received power of a synchronization signal transmitted from any other user equipment UE is less than a predetermined threshold value and a synchronization signal is transmitted while the transmission power is controlled. Details which are not particularly mentioned (for example, selection of a synchronization resource for transmitting a synchronization signal) may be the same as in the above-described embodiment.

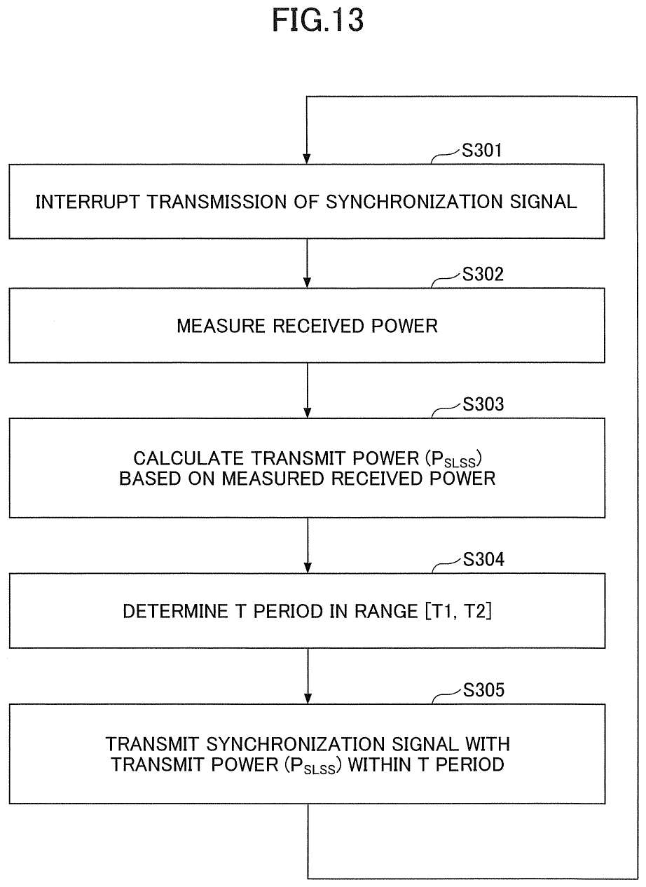

FIG. 13 is a flowchart illustrating an example of a processing sequence which is performed by user equipment according to the embodiment. First, user equipment UE interrupts transmission of a synchronization signal (S301) and measures the received power of a synchronization signal transmitted from any other user equipment UE (S302). The user equipment UE may measure the received power using multiple synchronization resources including the synchronization resource which is used to transmit the synchronization signal by the user equipment UE itself or may measure the received power using only the synchronization resource which is used to transmit the synchronization signal by the user equipment UE itself. When the received power is measured using multiple synchronization resources, a largest received power may be used to calculate the transmission power in the following processing sequence.

Subsequently, the user equipment UE calculates the transmission power (P_{SLSS}) on the basis of the measured received power (S303). Here, the user equipment UE may calculate the transmission power (P_{SLSS}) using an equation of “P_{SLSS}=P₀+α(SRSRPₘₑₐₛᵤᵣₑ−SRSRP₀).” Here, “SRSRPₘₑₐₛᵤᵣₑ” represents the measured received power. “P₀” represents reference transmission power for transmission power control. “α” represents a scaling ratio of the transmission power based on the received power. “SRSRP₀” represents offset power from SRSRPₘₑₐₛᵤᵣₑ. The values of “P₀,” “α,” and “SRSRP₀” may be specified as a standard specification in advance, may be configured from the base station eNB to the user equipment UE using broadcast information (SIB) or RRC signaling, or may be pre-configured in the user equipment UE via a SIM, a core network, or the like. Subsequently, the user equipment UE optionally determines a predetermined time interval “T period” indicating a period in which a synchronization signal can be transmitted between “T1 and T2” (S304). The user equipment UE may randomly determine the T period between T1 and T2 or may determine the T period on the basis of the magnitude of the received power measured in the processing sequence of Step S102. Subsequently, the user equipment UE transmits a synchronization signal with the calculated transmission power (P_{SLSS}) in the “T period” (S305).

According to the above-mentioned processing sequence, for example, when “α” is set to a negative value, the user equipment UE can operate to decrease the transmission power of its synchronization signal when the measured received power is large, and may operate to increase the transmission power of its synchronization signal when the measured received power is small.

The processing sequence of Step S304 may be omitted. In this case, the “T period” may be specified as a standard specification in advance, may be configured from the base station eNB to the user equipment UE using broadcast information (SIB) or RRC signaling, or may be pre-configured in the user equipment UE via a SIM, a core network, or the like.

This embodiment and the above-described embodiment may be combined. Specifically, user equipment UE synchronized with the GNSS 1 or the base station eNB may operate to transmit a synchronization signal when a synchronization signal transmitted from any other user equipment UE is not received or when the received power of a synchronization signal transmitted from any other user equipment UE is less than the predetermined threshold value, and to change the transmission power of a synchronization signal to be transmitted by the user equipment UE itself additionally on the basis of the received power of a synchronization signal transmitted from any other user equipment UE when the synchronization signal is transmitted.

The embodiment is described above. According to the embodiment, the user equipment UE transmitting a synchronization signal operates to transmit the synchronization signal regardless of whether a control signal and data are transmitted. As a result, it is possible to solve the problem in that the synchronization signal is transmitted in a toothless manner. According to the embodiment, the user equipment UE synchronized with the GNSS 1 or the like operates to control the transmission power of the synchronization signal. As a result, a problem can be solved such that the units of user equipment synchronized with the GNSS 1 or the like uselessly consume the radio resources and power of the units of user equipment by transmitting synchronization signals.

### Another Embodiment

In this embodiment, user equipment UE operates to transmit a synchronization signal only when a synchronization signal transmitted from user equipment UE not synchronized with the GNSS 1 and the base station eNB (that is, an isolated user equipment UE) is received (detected). For example, in the example illustrated in FIG. 6, the units of user equipment UE1 to UE3 operate to transmit synchronization signals when presence of the isolated user equipment UE4 (outside the coverage) is detected. The user equipment UE determined to transmit a synchronization signal operates to transmit the synchronization signal regardless of whether a control signal and data are transmitted.

In the embodiment, user equipment UE receiving a synchronization signal needs to distinguish a synchronization signal transmitted from user equipment UE not synchronized with the GNSS 1 and the base station eNB (that is, an isolated user equipment UE) from a synchronization signal transmitted from user equipment UE synchronized with the GNSS 1 or the base station eNB.

Accordingly, in the embodiment, a priority level is given to a synchronization signal in advance and user equipment UE operates to determine whether to transmit a synchronization signal on the basis of the priority level. More specifically, user equipment UE operates to compare a priority level of a received synchronization signal with a priority level of a synchronization signal with which the user equipment UE itself is synchronized and to transmit the synchronization signal by the user equipment UE itself when the priority level of the received synchronization signal is low. The user equipment UE operates to compare the priority level of the received synchronization signal with the priority level of the synchronization signal with which the user equipment UE itself is synchronized and to be synchronized with the received synchronization signal when the priority level of the received synchronization signal is higher.

The priority level of the synchronization signal may be configured in the user equipment in advance, for example, to increase the priority level in the order of “a synchronization signal transmitted from an isolated user equipment UE,” “a synchronization signal transmitted from user equipment UE synchronized with the base station eNB,” “a synchronization signal transmitted from user equipment UE synchronized with the GNSS,” “a synchronization signal transmitted from the base station eNB,” and “a synchronization signal transmitted from the GNSS 1” or may be configured in another order. In the embodiment, at least the priority level of “a synchronization signal transmitted from an isolated user equipment UE” is treated to be the lowest.

By setting the SLSSs of the “synchronization signal transmitted from an isolated user equipment UE,” the “synchronization signal transmitted from user equipment UE synchronized with the base station eNB,” and the “synchronization signal transmitted from user equipment UE synchronized with the GNSS” to different sequences, the synchronization signals may be distinguished by the user equipment UE. The synchronization signals may be distinguished by including information indicating a type of a synchronization signal in the PSBCH. It is not limited to these, and the synchronization signals may be distinguished by another method.

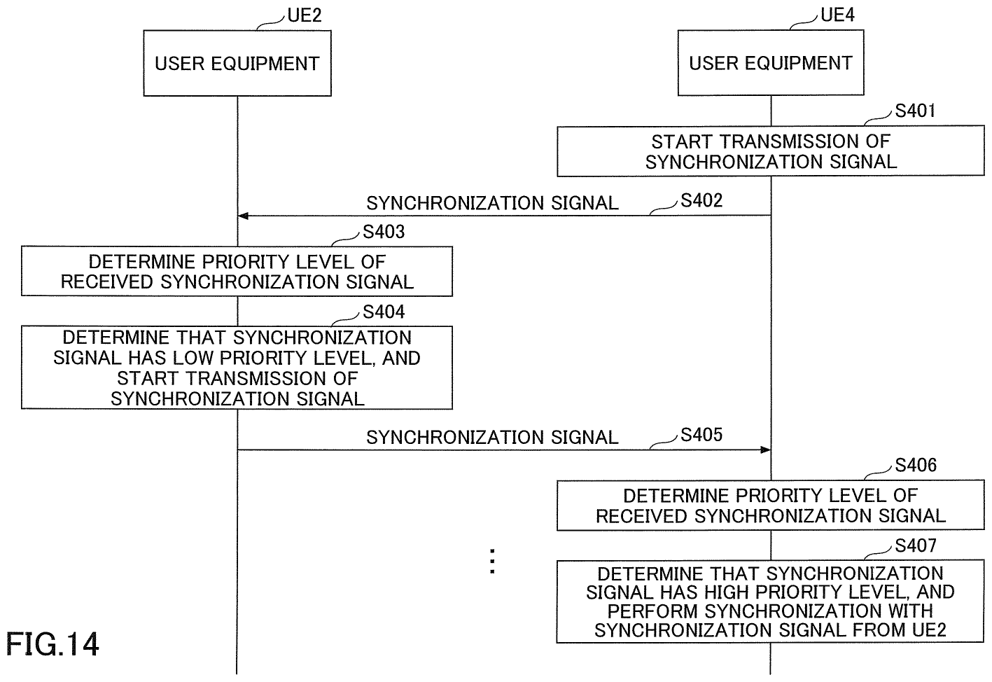

FIG. 14 is a sequence diagram illustrating an example of a processing sequence when user equipment according to the embodiment starts transmission of a synchronization signal. The user equipment UE2 and the user equipment UE4 illustrated in FIG. 14 correspond to the user equipment UE2 and the user equipment UE4 illustrated in FIG. 7, respectively. It is assumed that the user equipment UE2 is synchronized with the GNSS 1 and the user equipment UE4 is isolated.

First, the user equipment UE4 starts transmission of a synchronization signal, for example, to transmit a V2X packet (S401 and S402). Subsequently, the user equipment UE2 receives a synchronization signal transmitted from the user equipment UE4 and determines the priority level of the received synchronization signal. Since the user equipment UE2 is synchronized with the GNSS 1, the user equipment UE2 determines that the priority level of the received synchronization signal is lower than the priority level of the synchronization signal synchronized with which the user equipment UE2 itself is synchronized and starts transmission of a synchronization signal (S404 and S405). That is, the user equipment UE2 transmits the “synchronization signal transmitted from the user equipment UE synchronized with the GNSS” having a higher priority level than the “synchronization signal transmitted from an isolated user equipment UE.”

Subsequently, the user equipment UE4 determines the priority level of the synchronization signal transmitted from the user equipment UE2 (S406). Here, since the user equipment UE4 is not synchronized with an external synchronization signal, the user equipment UE4 determines that the synchronization signal having a high priority level is received, and the user equipment UE4 synchronizes with the received synchronization signal (S407). The user equipment UE4 may interrupt transmission of the synchronization signal which has been transmitted so far or may transmit (relay) the synchronization signal on the basis of the synchronization timing of the synchronization signal with which the user equipment UE4 is synchronized.

While the processing sequence is described above, which is for the user equipment UE detecting presence of the isolated user equipment UE to stat transmission of a synchronization signal, the user equipment UE may additionally interrupt transmission of the synchronization signal in accordance with the following processing sequence.

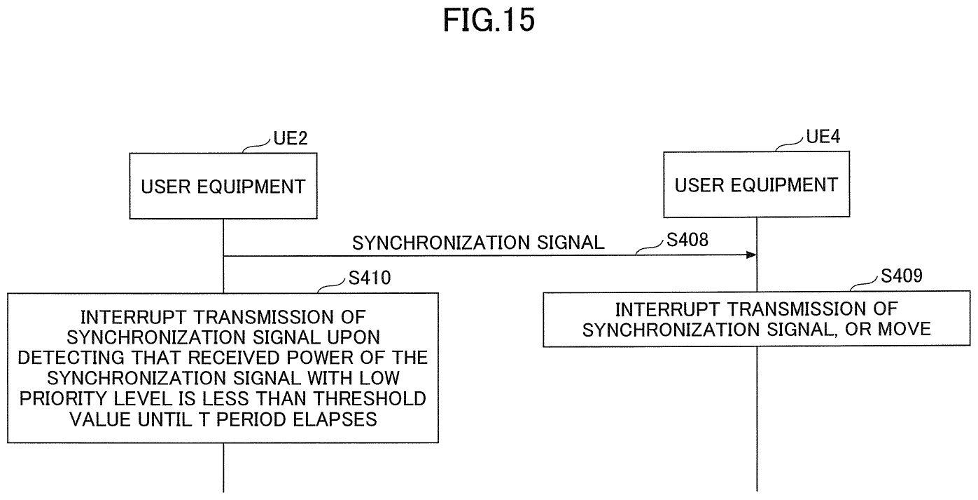

FIG. 15 is a sequence diagram illustrating an example of a processing sequence when user equipment according to the embodiment interrupts transmission of a synchronization signal.

The user equipment UE2 transmits a synchronization signal in accordance with the processing sequence of Steps S403 and S404 in FIG. 14 (S408). Subsequently, the user equipment UE4 is synchronized with the synchronization signal transmitted from the user equipment UE2 in accordance with the processing sequence of Steps S406 and S407 in FIG. 14 and interrupts transmission of the synchronization signal which has been transmitted so far (or moves away while transmitting the synchronization signal) (S409). The user equipment UE2 interrupts transmission of the synchronization signal upon detecting that the received power of the synchronization signal received from the user equipment UE4 is continuously less than the predetermined threshold value for a predetermined time interval “T period,” which indicates a period until transmission of the synchronization signal is interrupted (S410).

The T period may be a period from the timing at which the user equipment UE2 starts transmission of the synchronization signal or may be a period from the timing at which it is detected that the received power of the synchronization signal received from the user equipment UE4 is less than the predetermined threshold value (or the synchronization signal cannot be received). The user equipment UE may randomly determine the “T period” in a predetermined range of “T1 and T2.” The “T period” or/and the predetermined range of “T1 to T2” may be specified as a standard specification in advance, may be configured from the base station eNB to the user equipment UE using broadcast information (SIB) or RRC signaling, or may be pre-configured in the user equipment UE via a SIM, a core network, or the like.

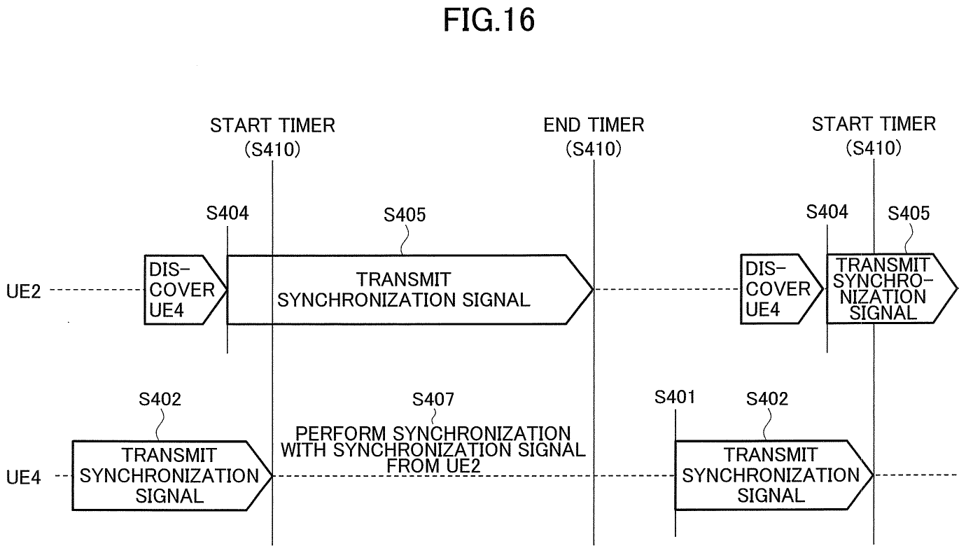

As described above, in the processing sequence described above with reference to FIGS. 14 and 15, when the user equipment UE4 synchronized with the synchronization signal transmitted from the user equipment UE2 operates to interrupt transmission of the synchronization signal, the operations of the user equipment UE2 and the user equipment UE4 can be illustrated as in FIG. 16. As illustrated in FIG. 16, the user equipment UE2 and user equipment UE4 operate to alternately repeat transmission and interruption of the synchronization signals. The user equipment UE4 is in an isolated state when the synchronization signal is not received from the user equipment UE2, but it is assumed that synchronization stability is not damaged when the time is not long.

The embodiment is described above. According to the embodiment, the user equipment UE transmitting a synchronization signal operates to transmit the synchronization signal regardless of whether a control signal and data are transmitted. Accordingly, it is possible to solve the problem in that the synchronization signal is transmitted in a toothless manner. According to the embodiment, the user equipment UE synchronized with the GNSS 1 or the like operates to transmit the synchronization signal only when presence of an isolated user equipment UE is detected. Accordingly, it is possible to solve the problem in that the units of user equipment synchronized with the GNSS 1 or the like uselessly consume the radio resources and power of the units of user equipment by transmitting synchronization signals.

### Modified Example of the Embodiment

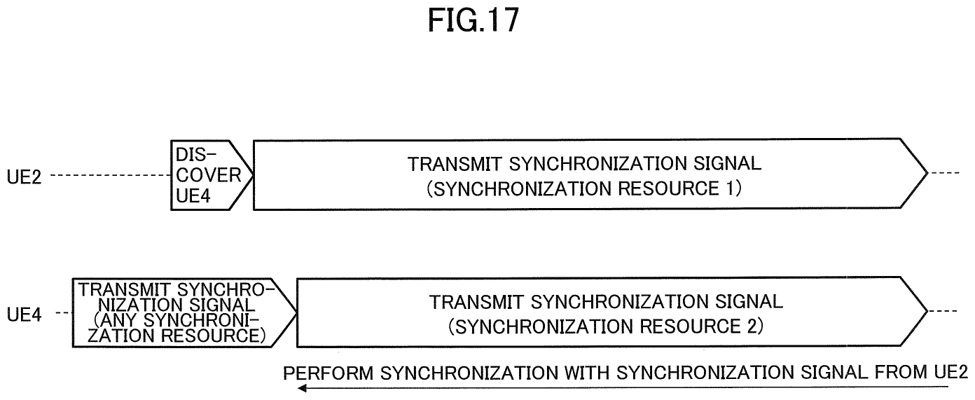

The user equipment UE2 may transmit a synchronization signal using a synchronization resource different from the synchronization resource of the synchronization signal received from the user equipment UE4 in the processing sequence of Step S404 of FIG. 14. The user equipment UE4 may transmit (relay) a synchronization signal using a synchronization resource different from the synchronization resource of the synchronization signal transmitted from the user equipment UE2 in the processing sequence of Step S407 of FIG. 14. In this case, the operations of the user equipment UE2 and the user equipment UE4 can be illustrated as in FIG. 17. As illustrated in FIG. 17, since the user equipment UE2 and the user equipment UE4 do not need to alternately repeat transmission/interruption of synchronization signals, it is possible to enhance synchronization stability. The user equipment UE4 can perform synchronization processing without interrupting transmission of the synchronization signal, which has been transmitted by the user equipment UE4 itself, so that the user equipment UE 4 can perform synchronization processing at high speed.

<Setting of Parameter Based on User Equipment State>

Various parameters which are used to transmit a synchronization signal which are described above in the embodiments may be configured for each user equipment UE state. For example, the user equipment UE state includes a position, a moving speed, and a Doppler frequency of the user equipment UE and capability of the user equipment UE. Various parameters include a received power threshold value (the predetermined threshold value), a synchronization signal transmission period (the T period), an offset of a subframe in which a synchronization signal is transmitted (an offset indicating a position of a synchronization resource), a hysteresis, and transmission power parameters (the values of “P₀,” “α,” and “SRSRP₀”). For example, by applying different received power threshold values by ranges of the moving speed of user equipment UE, user equipment UE which moves at high speed can be caused to transmit a synchronization signal in a wider received power range and other units of user equipment UE can be caused to transmit synchronization signals in a narrower received power range. Synchronization stability may be deteriorated during movement at high speed, such as extension of the time required for synchronization. By configuring the parameters based on the user equipment UE state, the synchronization stability can be enhanced.

<Functional Configuration>

Examples of functional configurations of user equipment UE and a base station eNB that perform the above-mentioned operations of the embodiments are described below. The user equipment UE and the base station eNB may have all the functions according to the embodiments, or may have only the functions according to any one of the embodiments. What function to perform may be switched depending on configuration information.

(User Equipment)

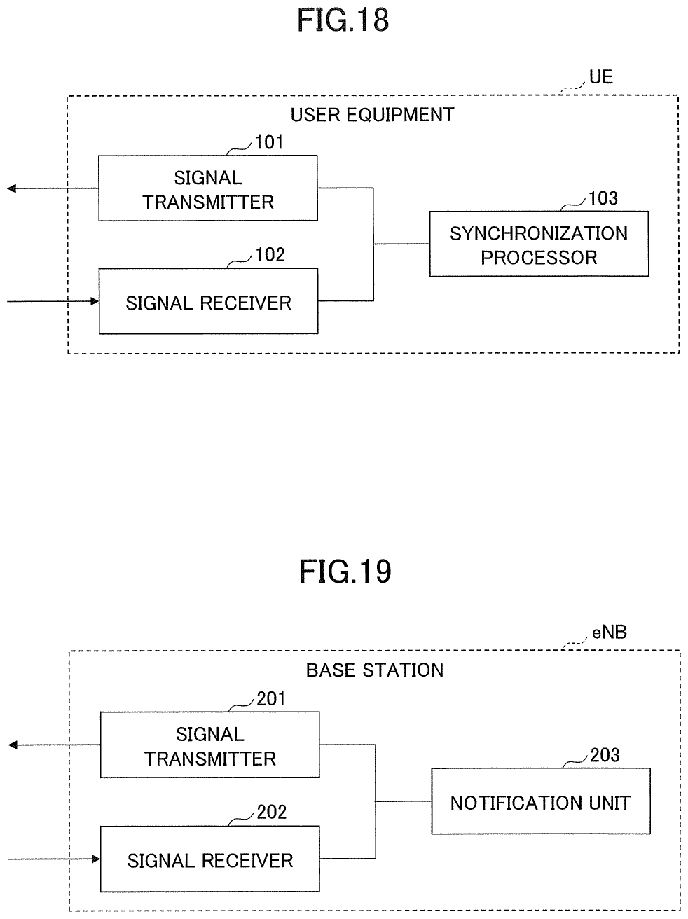

FIG. 18 is a diagram illustrating an example of the functional configuration of user equipment according to the embodiments. As illustrated in FIG. 18, user equipment UE includes a signal transmitter 101, a signal receiver 102, and a synchronization processor 103. FIG. 18 illustrates only the functional units of user equipment UE particularly relevant to the embodiments of the invention, and the user equipment may further include at least functions, which are not depicted, for performing operations conforming to the LTE. The functional configuration illustrated in FIG. 18 is only an example. The functional sections or the names of the functional units are not particularly limited as long as they can perform the operations according to the embodiments.

The signal transmitter 101 has a function of generating various signals of a physical layer from a signal of a higher layer to be transmitted from the user equipment UE and wirelessly transmitting the generated signals. The signal transmitter 101 has a function of transmitting a D2D signal and a transmitting function for cellular communication. The signal transmitter 101 has a function of transmitting a synchronization signal.

The signal receiver 102 has a function of wirelessly receiving various signals from any other user equipment UE or a base station eNB and retrieving a signal of a higher layer from the received signals of a physical layer. The signal receiver 102 has a function of receiving a D2D signal and a receiving function in cellular communication. The signal receiver 102 has a function of receiving a synchronization signal transmitted from a predetermined synchronization source (an external synchronization source, a base station eNB, or user equipment UE). The signal receiver 102 has a function of measuring received power of the synchronization signal. The signal receiver 102 may measure the received power of the synchronization signal transmitted from any other user equipment UE while the signal transmitter 101 interrupts transmission of a synchronization signal (for example, for a predetermined time interval).

The signal transmitter 101 may transmit a synchronization signal in a subframe (a synchronization resource) equal to or different from that of a synchronization signal transmitted from any other user equipment UE when the synchronization signal transmitted from any other user equipment UE is received by the signal receiver 102 and the received power of the synchronization signal transmitted from any other user equipment UE is less than the predetermined threshold value. The signal transmitter 101 may interrupt transmission of the synchronization signal for a predetermined time interval (T period). The signal transmitter 101 may interrupt transmission of the synchronization signal when the signal receiver 102 determines that the received power of the synchronization signal transmitted from any other user equipment UE is greater than the predetermined threshold value for a predetermined time interval.

The signal transmitter 101 may calculate transmission power for transmitting a synchronization signal on the basis of the received power, which is measured by the signal receiver 102, of the synchronization signal transmitted from any other user equipment UE and may transmit the synchronization signal with the calculated transmission power.

The signal transmitter 101 may transmit a synchronization signal having a higher priority level than that of a synchronization signal transmitted from any other user equipment UE when the synchronization signal transmitted from any other user equipment UE is received by the signal receiver 102 and the priority level of the synchronization signal transmitted from any other user equipment UE is lower than that of a predetermined synchronization signal. The signal transmitter 101 may interrupt transmission of the synchronization signal when the received power of the synchronization signal transmitted from any other user equipment UE is less than the predetermined threshold value for a predetermined time interval. The signal transmitter 101 may transmit the synchronization signal having a higher priority level than that of the synchronization signal transmitted from any other user equipment UE in a subframe (a synchronization resource) different from that of the synchronization signal transmitted from any other user equipment UE.

(Base Station)

FIG. 19 is a diagram illustrating an example of a functional configuration of a base station according to the embodiments. As illustrated in FIG. 19, the base station eNB includes a signal transmitter 201, a signal receiver 202, and a notification unit 203. FIG. 19 illustrates only the functional units of a base station eNB particularly relevant to the embodiments of the present invention, and the base station may further include at least functions, which are not depicted, for performing operations conforming to LTE. The functional configuration illustrated in FIG. 19 is only an example. The functional sections or the names of the functional units are not particularly limited as long as they can perform the operations according to the embodiments.

The signal transmitter 201 has a function of generating various signals of a physical layer from signals of a higher layer to be transmitted from the base station eNB and wirelessly transmitting the various signals. The signal receiver 202 has a function of wirelessly receiving various signals from user equipment UE and retrieving signals of a higher layer from the received signals of the physical layer.

The notification unit 203 notifies user equipment UE of a variety of information (such as a position of a synchronization resource, the value of the “T period,” the value of “T1,” the value of “T2,” the values of “P0,” “α,” and “SRSRP₀,” and a priority level of a synchronization signal) which is used for the user equipment UE to perform synchronization processing using broadcast signal (SIB) or RRC signaling.

All of the above-mentioned functional configurations of the base station eNB and the user equipment UE may be implemented by hardware circuits (for example, one or more IC chips), or a part thereof may be implemented by a hardware circuits and the other parts may be implemented by a CPU and programs.

(User Equipment)

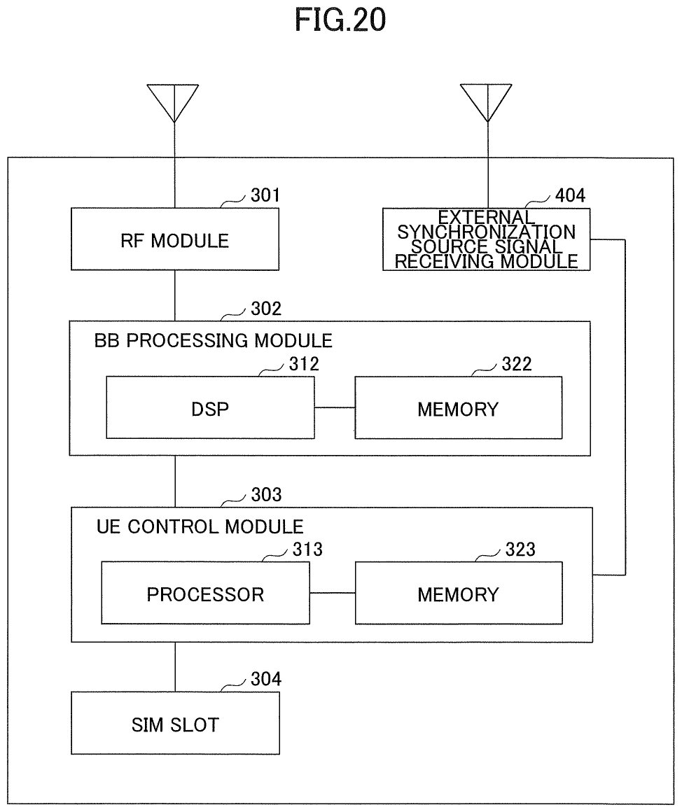

FIG. 20 is a diagram illustrating an example of a hardware configuration of user equipment according to the embodiments. FIG. 20 illustrates a configuration closer to an implementation example than FIG. 18. As illustrated in FIG. 20, user equipment UE includes an RF (Radio Frequency) module 301 that performs processing associated with radio signals, a BB (Base Band) processing module 302 that performs baseband signal processing, a UE control module 303 that processes a higher layer or the like, a SIM slot 304 that is an interface for accessing a SIM card, and an external synchronization source signal receiving module 305 that receives an external synchronization source signal.

The RF module 301 generates a radio signal to be transmitted from an antenna by performing D/A (Digital-to-Analog) conversion, modulation, frequency conversion, power amplification, and the like on a digital baseband signal received from the BB processing module 302. The RF module generates a digital baseband signal by performing frequency conversion, A/D (Analog-to-Digital) conversion, demodulation, and the like on a received radio signal and sends the generated digital baseband signal to the BB processing module 302. The RF module 301 includes, for example, a part of the signal transmitter 101 and the signal receiver 102 illustrated in FIG. 18.

The BB processing module 302 performs a process of converting an IP packet and a digital baseband signal into each other. A DSP (Digital Signal Processor) 312 is a processor that performs signal processing in the BB processing module 302. A memory 322 is used as a work area of the DSP 312. The RF module 301 includes, for example, a part of the signal transmitter 101, a part of the signal receiver 102, and the synchronization processor 103 which are illustrated in FIG. 18.

The UE control module 303 performs protocol processing of an IP layer, processing of various applications, and the like. A processor 313 is a processor that performs processing in the UE control module 303. A memory 323 is used as a work area of the processor 313. The processor 313 performs reading and writing of data to and from a SIM via the SIM slot 304.

The external synchronization source signal receiving module 305 receives a GPS signal and performs demodulation of the received GPS signal or the like. The external synchronization source signal receiving module 305 includes a part of the signal transmitter 101 illustrated in FIG. 18.

(Base Station)

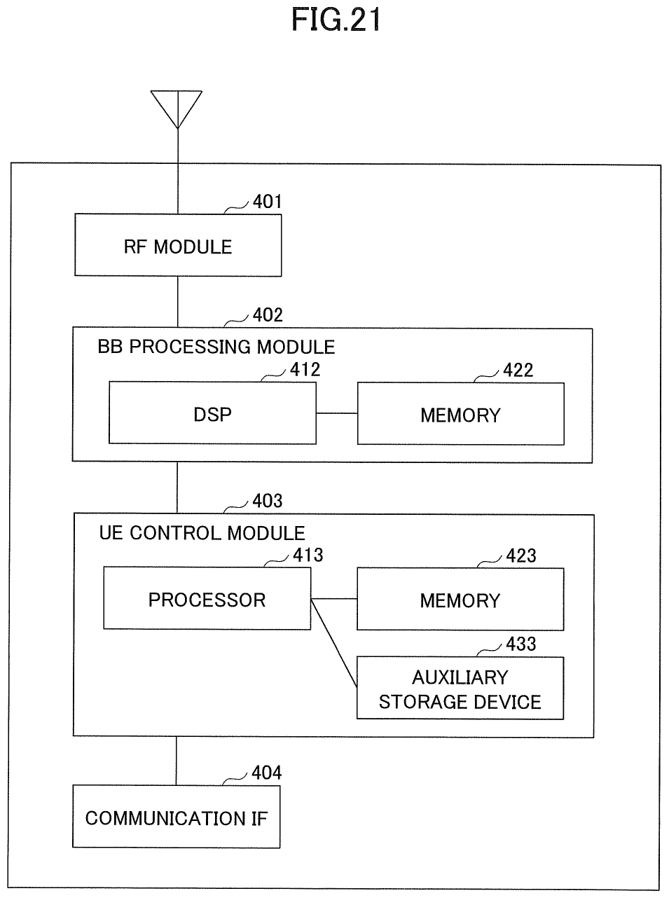

FIG. 21 is a diagram illustrating an example of a hardware configuration of a base station according to the embodiments. FIG. 21 illustrates a configuration closer to an implementation example than FIG. 19. As illustrated in FIG. 21, the base station eNB includes RF module 401 that processes a radio signal, a BB processing module 402 that processes a baseband signal, a device control module 403 that processes a higher layer or the like, and a communication IF 404 that is an interface for connection to a network.

The RF module 401 generates a radio signal to be transmitted from an antenna by performing D/A conversion, modulation, frequency conversion, power amplification, and the like on a digital baseband signal received from the BB processing module 402. The RF module generates a digital baseband signal by performing frequency conversion, A/D conversion, demodulation, and the like on a received radio signal and sends the generated digital baseband signal to the BB processing module 402. The RF module 401 includes, for example, a part of the signal transmitter 201 and the signal receiver 202 illustrated in FIG. 19.

The BB processing module 402 performs a process of converting an IP packet and a digital baseband signal into each other. A DSP 412 is a processor that performs signal processing in the BB processing module 402. A memory 422 is used as a work area of the DSP 412. The BB processing module 402 includes, for example, a part of the signal transmitter 201, a part of the signal receiver 202, and the notification unit 203 which are illustrated in FIG. 19.

The device control module 403 performs protocol processing of an IP layer, OAM (Operation and Maintenance) processing, and the like. A processor 413 is a processor that performs processing in the device control module 403. A memory 423 is used as a work area of the processor 413. An auxiliary storage device 433 is, for example, an HDD and stores a variety of setting information for operation of the base station eNB. The device control module 403 includes, for example, a part of the notification unit 203 illustrated in FIG. 19.

<Conclusion>

As described above, according to the embodiments, there is provided user equipment of a radio communication system that supports D2D communication, the user equipment including a receiver configured to receive a predetermined synchronization signal; a synchronization processor configured to perform a process for synchronizing with the predetermined synchronization signal; and a transmitter configured to transmit a synchronization signal in a subframe that is the same as that of a synchronization signal transmitted from any other user equipment when the synchronization signal transmitted from the other user equipment is received by the receiver and received power of the synchronization signal transmitted from the other user equipment is less than a predetermined threshold value, wherein the transmitter interrupts transmission of the synchronization signal for a predetermined time interval, and the receiver measures the received power of the synchronization signal transmitted from the other user equipment in the predetermined time interval. As a result, there is provided a technique that allows a synchronization process to be properly performed in D2D.

Further, according to the embodiments, there is provided user equipment of a radio communication system that supports D2D communication, the user equipment including a receiver configured to receive a predetermined synchronization signal; a synchronization processor configured to perform a process for synchronizing with the predetermined synchronization signal; and a transmitter configured to transmit a synchronization signal in a subframe different from that of a synchronization signal transmitted from any other user equipment when the synchronization signal transmitted from the other user equipment is received by the receiver and received power of the synchronization signal transmitted from the other user equipment is less than a predetermined threshold value, wherein the transmitter interrupts transmission of the synchronization signal when the received power of the synchronization signal transmitted from the other user equipment is greater than the predetermined threshold value for a predetermined time interval. As a result, there is provided a technique that allows a synchronization process to be properly performed in D2D.

Further, the transmitter calculates transmission power for transmitting the synchronization signal based on the received power of the synchronization signal transmitted from the other user equipment and may transmit the synchronization signal with the calculated transmission power. As a result, the user equipment UE receiving a synchronization signal can appropriately combine synchronization signals and enhance synchronization accuracy even in a situation in which multiple units of user equipment UE simultaneously transmit the synchronization signals, and thereby synchronization accuracy can be enhanced.

Further, according to the embodiment, there is provided user equipment of a radio communication system that supports D2D communication, the user equipment including a receiver configured to receive a predetermined synchronization signal; a synchronization processor configured to perform a process for synchronizing with the predetermined synchronization signal; and a transmitter configured to transmit a synchronization signal having a priority level higher than that of a synchronization signal transmitted from any other user equipment when the synchronization signal transmitted from the other user equipment is received by the receiver and the synchronization signal transmitted from the other user equipment has a priority level lower than that of the predetermined synchronization signal. As a result, there is provided a technique that allows a synchronization process to be properly performed.

Further, the transmitter may interrupt transmission of the synchronization signal when the received power of the synchronization signal transmitted from the other user equipment is less than a predetermined threshold value for a predetermined time interval. As a result, the user equipment UE transmitting a synchronization signal can interrupt transmission of the synchronization signal when it is not necessary to transmit the synchronization signal, such as a case where user equipment UE receiving the synchronization signal moves away.

Further, the transmitter may transmit the synchronization signal having the priority level higher than that of the synchronization signal transmitted from the other user equipment in a subframe different from that of the synchronization signal transmitted from the other user equipment. As a result, the user equipment UE receiving a synchronization signal can perform synchronization processing without interrupting transmission of the synchronization signal which is transmitted the user equipment UE itself, and thereby the synchronization process can be performed at high speed.

Further, according to the embodiment, there is provided a synchronization signal transmission method performed by user equipment of a radio communication system that supports D2D communication, the synchronization signal transmission method including: receiving a predetermined synchronization signal; performing a process for synchronizing with the predetermined synchronization signal; and transmitting a synchronization signal in a subframe that is the same as that of a synchronization signal transmitted from any other user equipment when the synchronization signal transmitted from the other user equipment is received in the receiving and received power of the synchronization signal transmitted from the other user equipment is less than a predetermined threshold value, wherein the transmitting interrupts transmission of the synchronization signal for a predetermined time interval, and the receiving measures the received power of the synchronization signal transmitted from the other user equipment in the predetermined time interval. As a result, there is provided a technique that allows a synchronization process to be properly performed in D2D.

Further, according to the embodiments, there is provided a synchronization signal transmission method performed by user equipment of a radio communication system that supports D2D communication, the synchronization signal transmission method including: receiving a predetermined synchronization signal; performing a process for synchronizing with the predetermined synchronization signal; and transmitting a synchronization signal in a subframe different from that of a synchronization signal transmitted from any other user equipment when the synchronization signal transmitted from the other user equipment is received in the receiving and received power of the synchronization signal transmitted from the other user equipment is less than a predetermined threshold value, wherein the transmitting interrupts transmission of the synchronization signal when the received power of the synchronization signal transmitted from the other user equipment is greater than the predetermined threshold value for a predetermined time interval. As a result, there is provided a technique that allows a synchronization process to be properly performed in D2D.

Further, according to the embodiments, there is provided a synchronization signal transmission method performed by user equipment of a radio communication system that supports D2D communication, the synchronization signal transmission method including: receiving a predetermined synchronization signal; performing a process for synchronizing with the predetermined synchronization signal; and transmitting a synchronization signal having a priority level higher than that of a synchronization signal transmitted from any other user equipment when the synchronization signal transmitted from the other user equipment is received in the receiving and the synchronization signal transmitted from the other user equipment has a priority level lower than that of the predetermined synchronization signal. As a result, there is provided a technique that allows a synchronization process to be properly performed in D2D.

### Additional Embodiments

The “T period” in the embodiments may be equal to each other or may be independent from each other.

In the embodiments, the “received power (S-RSRP)” may be replaced with receiving quality (RSRQ).

The embodiments may be combined in any manner.

The PSCCH may be another control channel as long as it is a control channel for transmitting control information (such as SCI) which is used for the D2D communication. The PSSCH may be another data channel as long as it is a data channel for transmitting data (such as MAC PDU) which is used for D2D communication of the D2D communication. The PSDCH may be another data channel as long as it is a data channel for transmitting data (such as a discovery message) which is used for D2D communication of the D2D discovery.

The configurations of the devices (user equipment UE/a base station eNB) which are described in the embodiments of the invention may be implemented by causing a CPU (a processor) to execute a program in the devices including the CP and the memory; may be implemented by hardware such as hardware circuit including processing logic described in the embodiments; or may be implemented by a mixture of a program and hardware.

The embodiments of the invention are described above. However, the disclosed invention is not limited to the embodiments and it is appreciated by those skilled in the art that various modifications, corrections, alternations, substitutions, and the like thereof are possible. Specific numerical values are used for description for the purpose of facilitating understanding of the invention, but the numerical values are only examples and appropriate different values may be used unless otherwise mentioned. Sections of items in the above description are not essential to the invention. Subject matter described in two or more items may be combined if necessary, or the subject matter described in a certain item may be applied to subject matter described in another item (as long as they do not contradict). The boundaries of the functional units or the processing units in the functional block diagrams do not necessarily correspond to boundaries of physical components. Operations of two or more functional units may be physically performed by a single component or an operation of one functional unit may be physically performed by two or more components. The sequences and the flowcharts described in the embodiments may be changed in the order as long as they do not contradict. For convenience of the description of the process, the user equipment UE/the base station eNB are described with reference to the functional block diagrams, but such devices may be implemented by hardware, by software, or by a combination thereof. Software which is executed by the processor of the user equipment UE according to the embodiments of the present invention and software which is executed by the processor of the base station eNB according to the embodiments of the present invention may be stored in a random access memory (RAM), a flash memory, a read only memory (ROM), an EPROM, an EEPROM, a register, a hard disk (HDD), a removable disk, a CD-ROM, a database, a server, or any appropriate storage medium.

In the embodiments, the synchronization signal transmitted from the GNSS 1 or the base station eNB is an example of a predetermined synchronization signal. The “backoff period” and the “T period” are examples of a predetermined period.

This international patent application is based upon and claims the benefit of priority of Japanese Patent Application No. 2016-020326 filed on Feb. 4, 2016 and the entire contents of Japanese Patent Application No. 2016-020326 are incorporated herein by reference.

### LIST OF REFERENCE SYMBOLS

UE User equipment
eNB Base station
101 Signal transmitter
102 Signal receiver
103 Synchronization processor
201 Signal transmitter
202 Signal receiver
203 Notification unit
301 RF module
302 BB processing module
303 UE control module
304 SIM slot
401 RF module
402 BB processing module
403 Device control module
404 Communication IF

1. User equipment of a radio communication system that supports D2D communication, the user equipment comprising:
a receiver configured to receive a predetermined synchronization signal;
a synchronization processor configured to perform a process for synchronizing with the predetermined synchronization signal; and
a transmitter configured to transmit a synchronization signal in a subframe that is the same as that of a synchronization signal transmitted from any other user equipment when the synchronization signal transmitted from the other user equipment is received by the receiver and received power of the synchronization signal transmitted from the other user equipment is less than a predetermined threshold value,
wherein the transmitter interrupts transmission of the synchronization signal for a predetermined time interval, and
the receiver measures the received power of the synchronization signal transmitted from the other user equipment in the predetermined time interval.

2. User equipment of a radio communication system that supports D2D communication, the user equipment comprising:
a receiver configured to receive a predetermined synchronization signal;
a synchronization processor configured to perform a process for synchronizing with the predetermined synchronization signal; and
a transmitter configured to transmit a synchronization signal in a subframe different from that of a synchronization signal transmitted from any other user equipment when the synchronization signal transmitted from the other user equipment is received by the receiver and received power of the synchronization signal transmitted from the other user equipment is less than a predetermined threshold value,
wherein the transmitter interrupts transmission of the synchronization signal when the received power of the synchronization signal transmitted from the other user equipment is greater than the predetermined threshold value for a predetermined time interval.

3. The user equipment according to claim 1, wherein the transmitter calculates transmission power for transmitting the synchronization signal based on the received power of the synchronization signal transmitted from the other user equipment and transmits the synchronization signal with the calculated transmission power.

4. User equipment of a radio communication system that supports D2D communication, the user equipment comprising:
a receiver configured to receive a predetermined synchronization signal;
a synchronization processor configured to perform a process for synchronizing with the predetermined synchronization signal; and
a transmitter configured to transmit a synchronization signal having a priority level higher than that of a synchronization signal transmitted from any other user equipment when the synchronization signal transmitted from the other user equipment is received by the receiver and the synchronization signal transmitted from the other user equipment has a priority level lower than that of the predetermined synchronization signal.

5. The user equipment according to claim 4, wherein the transmitter interrupts transmission of the synchronization signal when the received power of the synchronization signal transmitted from the other user equipment is less than a predetermined threshold value for a predetermined time interval.

6. The user equipment according to claim 4, wherein the transmitter transmits the synchronization signal having the priority level higher than that of the synchronization signal transmitted from the other user equipment in a subframe different from that of the synchronization signal transmitted from the other user equipment.

7. A synchronization signal transmission method performed by user equipment of a radio communication system that supports D2D communication, the synchronization signal transmission method comprising:
receiving a predetermined synchronization signal;
performing a process for synchronizing with the predetermined synchronization signal; and
transmitting a synchronization signal in a subframe that is the same as that of a synchronization signal transmitted from any other user equipment when the synchronization signal transmitted from the other user equipment is received in the receiving and received power of the synchronization signal transmitted from the other user equipment is less than a predetermined threshold value,
wherein the transmitting interrupts transmission of the synchronization signal for a predetermined time interval, and
the receiving measures the received power of the synchronization signal transmitted from the other user equipment in the predetermined time interval.

8. A synchronization signal transmission method performed by user equipment of a radio communication system that supports D2D communication, the synchronization signal transmission method comprising:
receiving a predetermined synchronization signal;
performing a process for synchronizing with the predetermined synchronization signal; and
transmitting a synchronization signal in a subframe different from that of a synchronization signal transmitted from any other user equipment when the synchronization signal transmitted from the other user equipment is received in the receiving and received power of the synchronization signal transmitted from the other user equipment is less than a predetermined threshold value,
wherein the transmitting interrupts transmission of the synchronization signal when the received power of the synchronization signal transmitted from the other user equipment is greater than the predetermined threshold value for a predetermined time interval.

9. A synchronization signal transmission method performed by user equipment of a radio communication system that supports D2D communication, the synchronization signal transmission method comprising:
receiving a predetermined synchronization signal;
performing a process for synchronizing with the predetermined synchronization signal; and
transmitting a synchronization signal having a priority level higher than that of a synchronization signal transmitted from any other user equipment when the synchronization signal transmitted from the other user equipment is received in the receiving and the synchronization signal transmitted from the other user equipment has a priority level lower than that of the predetermined synchronization signal.

10. The user equipment according to claim 2, wherein the transmitter calculates transmission power for transmitting the synchronization signal based on the received power of the synchronization signal transmitted from the other user equipment and transmits the synchronization signal with the calculated transmission power.
